(19) United States
(12) Patent Application Publication
(10) Pub. No.: US 2006/0177762 A1
(43) Pub. Date: Aug. 10, 2006

(54) Negative photosensitive resin composition and negative photosensitive element

(76) Inventors: Naoki Yamada, Ibaraki (JP); Manabu Saitou, Ibaraki (JP); Hiroyuki Tanaka, Ibaraki (JP); Hiroshi Yamazaki, Ibaraki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/564,853

(22) PCT Filed: Jul. 16, 2004
(86) PCT No.: PCT/JP04/10184

§ 371 Date: Jan. 17, 2006

(30) Foreign Application Priority Data
Jul. 17, 2003 (JP) 2003-27924
Sep. 11, 2003 (JP) 2003-319750

(51) Int. Cl. G02F 1/1337

(52) U.S. Cl. 430/270.1; 430/321; 430/325; 430/330; 349/124

(57) ABSTRACT

An object of the present invention is to provide a negative photosensitive resin composition, which is capable of forming projections for controlling liquid crystal alignment that exhibit a higher level of precision than that attained by projections formed mug a positive photosensitive resin composition, as well as a photosensitive element that uses the above negative photosensitive resin composition, which can be used in a transfer method (laminate system), is easily stored, can be used with no wastage, and exhibits excellent film thickness stability. The present invention relates to a negative photosensitive resin composition comprising an alkali-soluble resin (a), a reactive monomer (b), and a photoreaction initiator (c), wherein 50% or more of the total mass of the blended reactive monomer (b) is a monofunctional reactive monomer, and a negative photosensitive element comprising a negative photosensitive resin composition layer that uses the negative photosensitive resin composition positioned on top of a support.

### TECHNICAL FIELD

The present invention relates to a negative photosensitive resin composition, a negative photosensitive element, a method of producing projections having a curved surface or projections for controlling liquid crystal alignment using the resin composition and/or element, projections for controlling liquid crystal alignment obtained using the method, a substrate containing such projections for controlling liquid crystal alignment, and a liquid crystal panel that is produced using the substrate.

### BACKGROUND ART

Liquid crystal display devices (hereafter abbreviated as LCD), which exhibit picture quality rivaling that of a CRT (Cathode Ray Tube), and also offer the advantages of being thin and lightweight, are regarded as the image display devices that will replace CRT, and they are now being incorporated not only within OA equipment such as personal computers, but also within a multitude of consumer devices and household electronic equipment such as televisions, with this market expected to continue to expand.

Amongst LCD systems, TFT (Thin Film Transistor) LCD (hereafter abbreviated as TFT-LCD) account for the majority of large screen LCD systems, particularly screens of 10 inches or greater, owing to their rapid response speeds.

Conventionally, TFT-LCD generally uses a normally white mode TN (Twisted Nematic) LCD. However, one disadvantage of this TN system is that the desired display characteristics such as contrast and color reproducibility are only realized when the viewer views the screen from directly in front; namely, the viewing angle is narrow (viewing angle dependency). As a result, although TN-type TFT-LCD was adopted comparatively quickly for OA equipment, where operation by an individual is most common, its adoption within household appliances such as televisions, where a plurality of people can be expected to view a single screen, is, a plurality of people watch a single screen simultaneously from different viewing angles, has been much slower.

Furthermore, VA (Vertical Aligned) systems t use vertical alignment of the liquid crystal have been proposed as an alternative to TFT-LCD. Although VA systems exhibit significantly superior levels of response speed and contrast to TN systems, the problem of viewing angle dependency is similar to that observed for TN systems.

As a method of resolving the viewing angle dependency of VA systems, MVA (Multi-domain Vertical Alignment) systems have been proposed (for example, see Japanese Patent Publication No. 2,947,350 and Japanese Laid-Open Publication No 2000-193975). A characteristic feature of these systems is the reduction of the viewing angle dependency by providing projections on the liquid crystal layer-side of each of a pair of substrates, wherein these projections control the alignment of the liquid crystal on application of a voltage.

The reduction in the TFT-LCD viewing angle dependency achieved by using a MVA system facilitates the inclusion of LCD within household appliances typified by televisions, and as a result, LCD have quickly become widespread, not only for use within the more conventional OA equipment, but also as an alternative image display device to CRT within household appliances

The projections for controlling liquid crystal alignment that are required on the substrates for realizing a MVA system are generally formed using a liquid positive photosensitive resin composition. In other words, the projections are formed by layering a positive photosensitive resin composition onto the surface of the substrate using a wet process such as spin coating, forming a pattern using photoprocessing, and then conducting a curing treatment.

In a method in which the liquid resin composition is layered onto the substrate using a wet process, a variety of problems develop as the size of the substrate increases. Particularly in terms of layer thickness uniformity, factors such as slight wobbling of the substrate being layered, slight distortion within the substrate during layering, or surrounding air currents during layering can cause increases in the level of layer thickness fluctuation across a single substrate. Thickness fluctuations in the resin composition layer lead to fluctuations in the height of the projections for controlling the liquid crystal alignment, causing display irregularities. Furthermore, positive resin compositions generally exist as liquids, which can cause handling problems during usage and storage, and because the process of forming the resin composition layer on the substrate is a wet process, the quantity of resist that does not form part of the resin composition layer, but is simply discarded, is not insignificant.

### DISCLOSURE OF INVENTION

An aim of the present invention is to resolve the problems associated with the aforementioned liquid positive photosensitive resin compositions, and achieve the objects described below.

Namely, an object of the present invention is to provide a negative photosensitive resin composition, which is capable of forming projections for controlling liquid crystal alignment that exhibit a higher level of precision than that attained by projections formed using an aforementioned positive photosensitive resin composition.

Furthermore, another object of the present invention is to provide a photosensitive element that uses the above negative photosensitive resin composition, which can be used in a transfer method (laminate system), is easily stored, can be used with no wastage, and exhibits excellent film thickness stability.

Furthermore, another object of the present invention is to provide a method of producing projections having a curved surface that us the above negative photosensitive resin composition or photosensitive element.

Furthermore, another object of the present invention is to provide a method of producing projections for controlling liquid crystal alignment that uses the above negative photosensitive resin composition or photosensitive element.

Furthermore, another object of the present invention is to provide projections for controlling liquid crystal alignment that exhibit excellent uniformity.

Furthermore, another object of the present invention is to provide a substrate with projections for controlling liquid crystal alignment, which enables the production of a liquid crystal panel with a favorable yield.

In addition, another object of the present invention is to provide a liquid crystal panel with reduced viewing angle dependency, which can be used favorably not only within OA equipment, but also within household appliances.

In order to achieve these types of objects, the present invention provides a negative photosensitive resin composition comprising an alkali-soluble resin (a), a reactive monomer (b), and a photoreaction initiator (c), wherein 50% or more of the total mass of the blended reactive monomer is a monofunctional reactive monomer. In a preferred configuration, the negative photosensitive resin composition yields projections for controlling liquid crystal alignment wherein the surface shape of the projections is a smoothly curved surface, the height of the projections is within a range from 0.5 to 5 μm, and the precision of the height of the projections is no greater than ±0.1 μm.

Furthermore, the present invention also provides a photosensitive element, which comprises a negative photosensitive resin composition layer that uses an aforementioned negative photosensitive resin composition positioned on top of a support, as a negative photosensitive element that can be used in a transfer method (laminate system), is easily stored, can be used with no wastage, and exhibits excellent film thickness stability.

Furthermore, the present invention also provides a method of producing projections with curved surfaces, comprising at least: (I) a step of layering either the aforementioned negative photosensitive resin composition or a negative photosensitive resin composition layer of the aforementioned negative photosensitive element onto a substrate, thereby forming a negative photosensitive resin composition layer on top of the substrate, (II) a step of patterning the negative photosensitive resin composition layer by irradiation with an activation light beam, (III) a step of generating a resin pattern by developing, and (IV) a step of heating the resin pattern.

Furthermore, the present invention also provides a method of producing projections for controlling liquid crystal alignment comprising at least: (I) a step of layering either the aforementioned negative photosensitive resin composition or a negative photosensitive resin composition layer of the aforementioned negative photosensitive element onto a substrate, thereby forming a negative photosensitive resin composition layer on top of the substrate, (II) a step of patterning the negative photosensitive resin composition layer by irradiation with an activation light beam, (III) a step of generating a resin pattern by developing, and (IV) a step of generating projections with smoothly curved surfaces by heating.

Furthermore, the present invention also provides projections for controlling liquid crystal alignment produced using the above production method.

Furthermore, the present invention also provides a substrate having the aforementioned projections for controlling liquid crystal alignment.

In addition, the present invention provides a liquid crystal panel that is produced using a substrate having the aforementioned projections for controlling liquid crystal alignment.

This Application is based upon and claims the benefit of priority from prior Japanese Applications 2003-275924 filed on Jul. 17, 2003, and 2003-319750 filed on Sep. 11, 2003; the entire contents of which are incorporated by reference herein

### BRIEF DESCRIPTION OF TEE DRAWINGS

FIG. 1 is a schematic illustration showing a negative photosensitive resin composition of the present invention layered on top of a glass substrate, and a photomask positioned above the composition with a spacing of 100 μm. In the figure, numeral 1 represents the glass substrate, numeral 2 represents the negative photosensitive resin composition layer, and numeral 10 represents a photomask.

FIG. 2 is a schematic illustration showing a glass substrate and a resin pattern obtained on top of the glass substrate following exposure and alkali developing of a negative photosensitive resin composition of the present invention. In the figure, numeral 1 represents the glass substrate, and numeral 3 represents the resin pattern formed using the negative photosensitive resin composition.

FIG. 3 is schematic illustration showing a glass substrate with projections for controlling liquid crystal alignment according to the present invention. In the figure, numeral 1 represents the glass substrate, and numeral 4 represents a projection for controlling liquid crystal alignment.

### BEST MODE FOR CARRYING OUT THE INVENTION

In the following description of the present invention, although TFT-LCD structures are mostly used as examples, the present invention is not restricted to TFT-LCD, and can also be applied to any LCD system in which a liquid crystal layer is provided between a pair of substrates that each contain electrodes, and the alignment direction of the liquid crystal is then controlled, thereby generating a display, by applying a voltage across the electrodes, including simple matrix LCD and plasma addressed LCD, meaning applications of the present invention are not limited to TFT-LCD applications.

A negative photosensitive resin composition of the present invention comprises an alkali-soluble resin (a), a reactive monomer (b), and a photoreaction initiator (c), wherein 50% or more of the total mass of the blended reactive monomer is a monofunctional reactive monomer.

There are no particular restrictions on the alkali-soluble resin (a) used in the present invention, and suitable resins include those that dissolve or disperse in an alkaline developing solution, and exhibit sufficient solubility or dispersibility or the like to enable implementation of the targeted developing treatment. Examples of suitable resins include (meth)acrylic-based resins, hydroxystyrene resins, novolak resins, and polyester resins Of these various alkali-soluble resins (a), particularly preferably resins include copolymers of a monomer (1) and a monomer (2) described below.

Monomer 1: Carboxyl Group-Containing Monomers

Examples include acrylic acid, methacrylic acid, maleic acid, fumaric acid, crotonic acid, itaconic acid, citraconic acid, mesaconic acid, cinnamic acid, mono(2-(meth)acryloyloxyethyl) succinate, and co-carboxy-polycaprolactone mono(meth)acrylate.

Monomer 2: Other Copolymerizable Monomers

Examples include acrylate esters such as methyl(meth)acrylate, ethyl (meth)acrylate, n-butyl(meth)acrylate, n-lauryl(meth)acrylate, benzyl(meth)acrylate, glycidyl(meth)acrylate, dicyclopentanyl(meth)acrylate, 2-hydroxyethyl(meth)acrylate, 2-hydroxypropyl(meth)acrylate, and 3-hydroxypropyl(meth)acrylate; aromatic vinyl-based monomers such as styrene and α-methylstyrene; conjugated dienes such as butadiene and isoprene; macromonomers having a polymerizable unsawrated group such as a (meth)acryloyl group at one terminal of a polymer chain such as polystyrene, polymethyl(meth)acrylate, polyethyl(meth)acrylate, and polybenzyl(meth)acrylate; and phenolic hydroxyl group containing monomers such as o-hydroxystyrene, m-hydroxystyrene, and p-hydroxystyrene.

The proportion of the copolymer components derived from the monomer (1) is preferably from 1 to 50% by mass, and even more preferably from 5 to 300/c by mass. The molecular weight of the alkali-soluble resin (a), expressed as a polystyrene equivalent weight average molecular weight determined by GPC (hereafter also referred to as simply the weight average molecular weight (Mw)) is preferably within a range from 5,000 to 5,000,000, and even more preferably from 10,000 to 300,000. The acid value of the alkali-soluble resin (a) is preferably within a range from 20 to 300 (KOHmg/g), even more preferably from 30 to 250 (KOHmg/g), and most preferably from 50 to 150 (KOHmg/g). If the acid value is less than 20 (KOHmg/g) then developing in an aqueous alkali solution becomes problematic, whereas if the acid value exceeds 300 (KOHmg/g), separation of the resin pattern from the substrate becomes a common occurrence.

In the present invention, the use of (meth)acrylic acid as the monomer (1) is preferred, and the use of a (meth)acrylate ester as the monomer (2) is preferred.

The reactive monomer (b) used in the present invention is characterized in that 50% or more of the total mass of the blended reactive monomer is a monofunctional reactive monomer, that is, a reactive monomer containing one ethylenic unsaturated bond within the molecule. Suitable examples of this monofunctional reactive monomer include nonylphenylpolyoxyethylene(meth)acrylate, phthalic acid-based compounds such as γ-chloro-β-hydroxypropyl-β′-(meth)acyloyloxyethyl-o-phthalate, β-hydroxyethyl-β′-(meth)acryloyloxyethyl-o-phthalate and β-hydroxypropyl-β′-(meth)acryloyloxyethyl-o-phthalate, and alkyl(meth)acrylates such as methyl(meth)acrylate, ethyl(meth)acrylate, butyl(meth)acrylate and 2-ethylhexyl(meth)acrylate. There are no particular restrictions on the monofunctional reactive monomer in the present invention, provided it is capable of realizing projections with smoothly curved surfaces, although in order to achieve such smoothly curved surfaces, a phthalic acid-based compound is preferred. These monofunctional reactive monomers can be used either alone, or in combinations of two or more different compounds.

These monofunctional reactive monomers may also be used in combination with other polyfunctional reactive monomers, namely, reactive monomers containing two or more ethylenic unsaturated bonds within each molecule. Suitable examples include compounds obtained by reacting a polyhydric alcohol with an α,β-unsaturated carboxylic acid, bisphenol A-based (meth)acrylate compounds, compounds obtained by reacting a glycidyl group-containing compound with an α,β-unsaturated carboxylic acid, and (meth)acrylate compounds containing a urethane linkage within the molecule.

Examples of the aforementioned compounds obtained by reacting a polyhydric alcohol with an α,β-unsaturated carboxylic acid include polyethylene glycol di(meth)acrylates with 2 to 14 ethylene groups, polypropylene glycol di(meth)acrylates with 2 to 14 propylene groups, trimethylolpropane di(meth)acrylate, trimethylolpropane tri(meth)acrylate, trimethylolpropane ethoxy tri(meth)acrylate, trimethylolpropane diethoxy tri(meth)acrylate, trimethylolpropane triethoxy tri(meth)acrylate, trimethylolpropane tetraethoxy tri(meth)acrylate, trimethylolpropane pentaethoxy tri(meth)acrylate, tetramethylolmethane tri(meth)acrylate, tetramethylolmethane tetra(meth)acrylate, pentaerythritol tri(meth)acrylate, dipentaerythritol tetra(meth)acrylate, dipentaerythritol penta(meth)acrylate, and dipentaerythritol hexa(meth)acrylate.

A suitable example of the aforementioned α,β-unsaturated carboxylic acid is (meth)acrylic acid.

Examples of the aforementioned bisphenol A-based (meth)acrylate compounds, that is, 2,2-bis(4-((meth)acryloxypolyethoxy)phenyl)propanes, include 2,2-bis(4 ((meth)acryloxydiethoxy)phenyl)propane, 2,2-bis(4-((meth)acryloxytriethoxy)phenyl)propane, 2,2-bis(4-((meth)acryloxypentaethoxy)phenyl)propane, and 2,2-bis(4-((meth)acryloxydecaethoxy)phenyl)propane, and of these, 2,2-bis(4-((meth)acryloxypentaethoxy)phenyl)propane is available commercially under the brand name BPE-500 (manufactured by Shin-Nakamura Chemical Co., Ltd.).

Examples of the aforementioned compounds obtained by reacting a glycidyl group containing compound with an α,β-unsaturated carboxylic acid include trimethylolpropane triglycidyl ether tri(meth)acrylate and 2,2-bis(4-((meth)acryloxy-2-hydroxy-propyloxy)phenyl)propane.

Examples of the aforementioned (meth)acrylate compounds containing a urethane linkage within the molecule include addition reaction products of a (meth)acrylic monomer with an OH group at the β-position, with isophorone diisocyanate, 2,6-toluene diisocyanate, 2,4-toluene diisocyanate or 1,6-hexamethylene diisocyanate, as well as tris((meth)acryloxy tetraethylene-glycol isocyanate)hexamethylene isocyannurate, EO-modified urethane di(meth)acrylate, and EO,PO-modified urethane di(meth)acrylate. EO represents ethylene oxide, and EO-modified compounds contain an ethylene oxide group block structure. Furthermore, PO represents propylene oxide, and PO-modified compounds contain a propylene oxide group block structure.

These reactive monomers containing two or more ethylenic unsaturated bonds within each molecule can be used either alone, or in combinations of two or more different compounds. There are no particular restrictions on the polyfunctional reactive monomer in the present invention, provided it is capable of realizing projections with smoothly curved surfaces, although in order to achieve such smoothly curved surfaces, a bisphenol A (meth)acrylate-based compound is preferred.

Within the blended reactive monomer, the proportion of the monofunctional reactive monomer is preferably from 50 to 90%, even more preferably from 60 to 85%, and most preferably from 70 to 80%, of the total mass of the reactive monomer if the proportion of the monofunctional reactive monomer is 90% or higher, then curing of the pattern may became inadequate, causing a deterioration in the precision of the thickness of the obtained pattern.

Examples of the photoreaction initiator (c) used in the present invention include aromatic ketones such as benzophenone, N,N,N′,N′-trimethyl-4,4′-diaminobenzophenone (Michler's ketone), N,N,N′,N′-tetraethyl-4,4′-diaminobenzophenone, 4-methoxy-4′-diethylaminobenzophenone, 2-benzyl-2-dimethylamino-1-(4-morpholinophenyl)-butanone-1,2,2-dimethoxy-1,2-diphenylethan-1-one, 1-hydroxycyclohexyl phenyl ketone, and 2-methyl-1-(4-(methylthio)phenyl)-2-morpholinopropanone-1 thioxanthones such as 2-ethylthioxanthone, 2-propylthioxanthone, 2-isopropylthioxanthone, 2,4-dimethylthioxanthone, and 2,4-diethylthioxanthone; quinones such as 2-ethylanthraquinone, phenanthrenequinone, 2-t-butylanthraquinone, octamethylanthraquinone, 1,2-benzanthraquinone, 2,3-benzanthraquinone, 2-phenylanthraquinone, 2,3-diphenylanthraquinone, 1-chloroanthraquinone, 2-methylanthraquinone, 1,4-naphthoquinone, 9,10-phenanthraquinone, 2-methyl-1,4-naphthoquinone, and 2,3-dimethylanthraquinone; benzoin ethers such as benzoin methyl ether, benzoin ethyl ether and benzoin phenyl ether; benzoins such as benzoin, methylbenzoin, and ethylbenzoin; benzyl derivatives such as benzyl methyl ketal; 2,4,5-triarylimidazole dimers such as 2-(o-chlorophenyl)-4,5-diphenylimidazole dimer, 2-(o-chlorophenyl)-4,5-di(m-methoxyphenyl)imidazole dimer, 2-(o-fluorophenyl)-4,5-phenylimidazole dimer, 2-(o-methoxyphenyl)-4,5-diphenylimidazole dimer, 2-(p-methoxyphenyl)-4,5-diphenylimidazole dimers 2,4-di(p-methoxyphenyl)-5-phenylimidazole dimer, and 2-2,4-dimethoxyphenyl)_{4,5}-diphenylimidazole dimer; benzimidazoles such as 2-mercaptobenzimidazole; acridine derivatives such as 9-phenylacridine and 1,7-bis(9,9′-acridinyl)heptane; as well as N-phenylglycine, derivatives of N-phenylglycine, and coumarin-based compounds.

Furthermore, in the 2,4,5-triarylimidazole dimers, the substituent groups within the two 2,4,5-triarylimidazoles may be either the same or different. Furthermore, thioxanthone-based compounds and tertiary amine compounds may be combined, such as a combination of diethylthioxanthone and dimethylaminobenzoic acid. Furthermore, from the viewpoints of adhesion and sensitivity, the use of 2,4,5-triarylimidazole dimers is preferred. These compounds can be used either alone, or in combinations of two or more different compounds.

A negative photosensitive resin composition of the present invention preferably comprises from 65 to 80 parts by mass of the alkali-soluble resin (a), and from 20 to 35 parts by mass of the reactive monomer (b). If the quantity of the alkali-soluble resin (a) is less than 65 parts by mass then the adhesion of the composition to the substrate may deteriorate, whereas if the quantity exceeds 80 parts by mass, obtaining projections with smoothly curved surfaces in a stable manner may become difficult.

The quantity of the photoreaction initiator (c) used in the present invention is preferably with a range from 0.1 to 10 parts by mass per 100 parts by mass of the combined mass of the components (a) and (b). If this quantity is less than 0.1 parts by mass, the photosensitivity tends to be inferior, whereas if the quantity exceeds 10 parts by mass, the heat resistance tends to decrease.

Furthermore, in addition to the components described above, dyes, color fixing agents, plasticizers, pigments, polymerization inhibitors, surface modifiers, stabilizers, adhesion-imparting agents, and thermal curing agents and the like can also be added, as required, to a negative photosensitive resin composition of the present invention. These additives can be used either alone, or in combinations of two or more different materials.

In addition, if required, a negative photosensitive resin composition of the present invention may be dissolved in a solvent prior to use. Examples of suitable solvents include methanol, ethanol, propanol, isopropanol, 1-methoxy-2-propanol, acetone, methyl ethyl ketone, methyl isobutyl ketone, methyl cellosolve, ethyl cellosolve, toluene, ethyl acetate, ethyl lactate, acetonitrile, tetrahydrofuran, chloroform, N,N-dimethylformamide, and propylene glycol monomethyl ether. These solvents can be used either alone, or in combinations of two or more different solvents, but from the viewpoint of facilitating drying during formation of the resin composition layer, acetone, methyl ethyl ketone and toluene are preferred.

The thickness of the negative photosensitive resin composition layer in the present invention is needed only to be sufficient to eventually obtain projections of the targeted height, and is preferably within a range from 1 to 15 μm, even more preferably from 2 to 12 μm, and most preferably from 3 to 9 μm.

By using a negative photosensitive resin composition of the present invention, projections for controlling liquid crystal alignment can be obtained which exhibit favorable heat resistance and chemical resistance, wherein the surface shape of the projections is a smoothly curved surface, the height of the projections is from 0.5 to 5 μm, and the precision of the height of the projections is no greater than ±0.1 μm. Furthermore, in the present invention, the height of a projection refers to the height from the substrate surface to the peak of the projection, and the precision of the height of the projections refers to the breadth of the range across which the heights of the obtained projections vary for a single substrate.

A negative photosensitive element of the present invention is obtained by layering an aforementioned negative photosensitive resin composition onto a suitable support. Conventional materials can be used with no particular restrictions as the support, but from the viewpoints of enabling the negative photosensitive element to be laminated with favorable adhesion to a substrate, and then ensuring favorable peeling properties for the support following laminating of the negative photosensitive element and subsequent patterning with an activation light beam, a film with a thickness of approximately 5 to 100 μm formed from a polyolefin such as polypropylene or a polyester such as polyethylene terephthalate or the like is preferred. Furthermore, a cover film may also be laminated on top of the negative photosensitive element. Examples of the cover film include films with a thickness of approximately 5 to 100 μm formed from polyethylene, polypropylene, polyethylene terephthalate or polycarbonate or the like, and these cover films enable the negative photosensitive element of the present invention to be wound into a roll for storage.

Conventional methods can be used for the method of layering the negative photosensitive resin composition of the present invention, and suitable methods include doctor blade coating, Meyer bar coating, roll coating, screen coating, spinner coating, inkjet coating, spray coating, dip coating, gravure coating, and curtain coating. The drying temperature is preferably within a range from 60 to 130° C., and the drying time is preferably within a range from one minute to one hour.

In the present invention, projections with curved surfaces can be produced by conducting at least; (r) a step of either layering (coating) the negative photosensitive resin composition onto a subsume, or layering (laminating) the negative photosensitive resin composition layer of the negative photosensitive element onto a substrate, thereby forming a negative photosensitive resin composition layer on top of the substrate, (II) a step of patterning the negative photosensitive resin composition layer by irradiation with an activation light beam, (I) a step of generating a resin pattern by developing, and (IV) a step of heating the resin pattern.

Furthermore, in a similar manner, projections for controlling liquid crystal alignment in accordance with the present invention can be produced by conducting at least: (1) a step of either layering (coating) the negative photosensitive resin composition onto a substrate, or layering (laminating) the negative photosensitive resin composition layer of the negative photosensitive element onto a substrate with good adhesion, thereby forming a negative photosensitive resin composition layer on top of the substrate, (II) a step of patterning the negative photosensitive resin composition layer by irradiation with an activation light beam, (III) a step of using developing to selectively remove those portions of the resin composition layer that were not irradiated with the activation light beam, thereby forming a patter from the resin composition, and (IV) a step of generating projections with smoothly curved surfaces by heating.

The developing is conducted using an aqueous alkali solution, using a conventional method such as a dipping system spray system, brushing or slapping or the like. If required, two or more developing methods may be combined. Examples of suitable aqueous alkali solutions include dilute solutions of sodium carbonate with concentrations of 0.1 to 5% by weight, dilute solutions of potassium carbonate with concentrations of 0.1 to 5% by weight, and dilute solutions of sodium hydroxide with concentrations of 0.1 to 5% by weight. The pH of the aqueous alkali solution is preferably within a range from 9 to 11, and the temperature of the solution is adjusted in accordance with the developability of the negative photosensitive resin composition layer. Furthermore, the aqueous alkali solution may also include surfactants, antifoaming agents, and organic solvents and the like.

The heating temperature is preferably within a range from 200 to 300° C., even more preferably from 230 to 280° C., and most preferably from 250 to 260° C. The heating time period is preferably at least 0.5 hours, even more preferably within a range from 0.5 to 5 hours, and most preferably from 1 to 2 hours. The activation light beam of the present invention can use conventional activation light sources, and suitable examples include carbon arc lamps, ultra high pressure mercury lamps, high pressure mercury lamps, and xenon lamps, and there are no particular restrictions provided the light source is able to effectively irradiate an activation light beam of ultraviolet light or the like. The irradiation dose from this activation light beam during irradiation is typically within a range from 10 to 1×10⁴ mJ/cm², and heat may also be applied during the irradiation. If this activation light irradiation dose is less than 10 mJ/cm² then the desired effect may be inadequate, whereas if the dose exceeds 1×10⁴ mJ/cm², the photosensitive resin layer tends to discolor.

An example of the substrate onto which the negative photosensitive resin composition layer is formed is a transparent substrate that exhibits favorable transmittance of visible light and is consequently suited to the display of images. Examples of this transparent substrate include substrates with a thickness of approximately 0.1 to 5 mm formed from a glass plate or a synthetic resin plate or the like, on which have been formed electrodes for driving the liquid crystal. Examples of these liquid crystal driving electrodes include ITO (indium tin oxide) electrodes and the like.

An example of a method of layering (laminating) the negative photosensitive element of the present invention onto a substrate with good adhesion, for example in the case where the element includes a cover film, involves peeling away and removing the cover film while the element and the substrate are subjected to pressure bonding using a laminator or the like. The bonding pressure of the laminating rollers in such a case, expressed as a linear pressure, is preferably within a range from 50 to 1×10⁵ N/m, even more preferably from 2.5×10² to 5×10⁴ N/m, and most preferably from 5×10² to 4×10⁴ N/m. If this bonding pressure is less than 50 N/m then satisfactory adhesion tends to be unobtainable, whereas if the bonding pressure exceeds 1×10⁵ N/m, the photosensitive element tends to become prone to edge fusion. Furthermore, the lamination temperature is preferably within a range from 100 to 160° C., and even more preferably from 110 to 130° C.

A substrate having projections for controlling liquid crystal alignment according to the present invention can be obtained, for example, by forming, on an aforementioned substrate, projections for controlling liquid crystal alignment comprising the negative photosensitive resin composition that has undergone patterning and curing treatment in accordance with the production steps described above.

A liquid crystal panel that employs a substrate having projections for controlling liquid crystal alignment according to the present invention can be obtained, for example, by bonding together either two of the aforementioned substrates having projections for controlling liquid crystal alignment, or one such substrate having projections for controlling liquid crystal alignment and one separately prepared substrate, with a suitable spacing between the two substrates, injecting liquid crystal into the spacing, and then sealing the spacing using a sealing agent or the like. In order to enable liquid crystal driving, the liquid crystal panel includes wiring for connection to appropriate driver ICs and the like.

In the present invention, by ensuring that 50% or more of the total mass of the blended reactive monomer is a monofunctional reactive monomer, the formation of projections for controlling liquid crystal alignment, that has conventionally only be achievable using positive photosensitive resin compositions, can also be achieved using a negative photosensitive resin composition. Furthermore, the projections for controlling liquid crystal alignment produced using the aforementioned negative photosensitive resin composition exhibit excellent thickness precision meaning that compared with the case in which a positive photosensitive resin composition is used, a substrate having more uniform projections for controlling liquid crystal alignment can be obtained, and a liquid crystal panel that uses the substrate can be produced with excellent yield.

### EXAMPLES

Next is a description of specifics of the present invention, based on a series of examples.

### Example 1

<Negative Photosensitive Resin Composition in which 50% or More of the Total Mass of the Reactive Monomers is a Monofunctional Reactive Monomer>

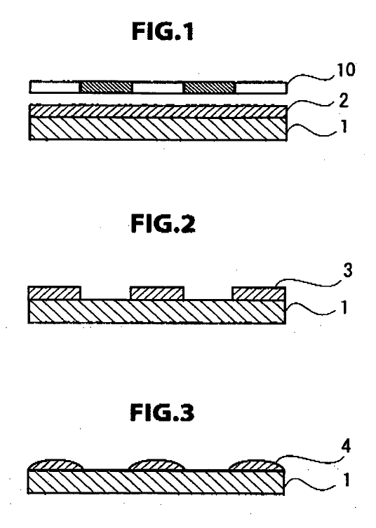

A negative photosensitive resin composition was prepared with the composition shown in table 1, a spin coating method was used to apply the composition to a glass substrate (3 cm×3 cm, thickness: 0.5 mm), and the composition was dried for three minutes using a hot air convection dryer, thereby forming a negative photosensitive resin composition layer (thickness: 4 μm), and completing preparation of a layered product wherein the glass substrate and the negative photosensitive resin composition layer had been layered together (FIG. 1). A photomask was positioned above the layered substrate, on the side of the negative photosensitive resin composition layer, with a spacing of 100 μm, and the composition was then irradiated through the photomask with a 3 kW ultra high pressure mercury lamp (HMW-590, manufactured by Orc Seisakusho Co., Ltd.), using an ultraviolet light beam of 100 mJ/cm² (FIG. 2). Following the ultraviolet light exposure, the layered product was subjected to spray developing Bug a developing solution containing 0.5 wt % of potassium carbonate and 0.5 wt % of a surfactant, thereby yielding a substrate with the desired resin pattern. Although this resin pattern had a rectangular cross-section, curing the substrate by heating at 250° C. for one hour yielded a substrate with projections for controlling liquid crystal alignment that exhibited the desired smoothly curved surfaces (FIG. 3, Table 2).

### Example 2

The negative photosensitive resin composition of the example 1 was applied to a polyethylene terephthalate film (a support) of thickness 50 μm using a die coating method, in sufficient quantity to generate a dried film thickness of 4 μm, and following drying for three minutes using a hot air convection dryer at 110° C., the composition was covered with a polypropylene film of thickness 30 μm that functioned as a cover film, thereby completing preparation of a negative photosensitive element. The polypropylene film was then peeled off the thus obtained negative photosensitive element while the negative photosensitive resin composition layer was bonded laminated) with favorable adhesion to a glass substrate (3 cm×3 cm, thickness: 0.5 mm), under conditions including a roller temperature of 130° C., a roller linear pressure of 1500 N/m, and a speed of 1.0 m/minute, thereby completing preparation of a substrate comprising the glass substrate, the negative photosensitive resin composition layer, and the support layered together. The substrate support was then removed, and exposure, developing, and curing were conducted in the same manner as the example 1, yielding projections for controlling liquid crystal alignment (Table 2).

### Comparative Example 1

<Negative Photosensitive Resin Composition in which the Proportion of Monofunctional Reactive Monomer within the Total Mass of the Reactive Monomers is Less than 50%>

A negative photosensitive resin composition was prepared with the composition shown in Table 1, and a spin coating method was used to apply the composition to a glass substrate (3 cm×3 cm, thickness: 0.5 mm), thereby forming a negative photosensitive resin composition layer (thickness: 4 μm), and completing preparation of a layered product wherein the glass substrate and the negative photosensitive resin composition layer had been layered together. A photomask was positioned above the layered sure, on the side of the negative photosensitive resin composition layer, with a spacing of 100 μm, and the composition was then irradiated through the photomask with a 3 kW ultra high pressure mercury lamp (HMW-590, manufactured by Orc Seisakusho Co., Ltd.), using an ultraviolet light beam of 300 mJ/cm². Following the ultraviolet light exposure, the layered product was subjected to spray developing using a developing solution containing 0.5 wt % of potassium carbonate and 0.5 wt % of a surfactant, thereby yielding a substrate with the desired resin pattern. This resin pattern had a rectangular cross-section, and inspection of the pattern after curing the substrate by heating at 250° C. for one hour revealed that the resin pattern was still rectangular, meaning a substrate with the desired projections for controlling liquid crystal alignment with smoothly curved surfaces could not be obtained (Table 2).

### Comparative Example 2

A positive liquid resist was applied to a glass substrate (3 cm×3 cm, thickness: 0.5 mm) using a spin coating method, thereby forming a positive photosensitive resin composition layer (thickness: 4 μm), and completing preparation of a layered product wherein the glass substrate and the positive photosensitive resin composition layer had been layered together. Using a photomask that yielded a resin pattern with similar dimensions to those of the examples 1 and 2, exposure was conducted in the same manner as the example 1. Following exposure, developing was conducted using a 0.5% aqueous solution of TMAH, thereby yielding a substrate with the desired resin pattern. The substrate comprising the resin pattern was heated at 220° C. for one hour to cure the resin pattern, and a substrate having projections for controlling liquid crystal alignment with smoothly curved surfaces was obtained, but the thickness precision was inferior to that observed for the examples 1 and 2 (Table 2).

<Evaluation of Pattern Heat Resistance>

The substrates having projections for controlling liquid crystal alignment obtained in the examples 1 and 2 and the comparative example 2 were heated at 250° C. for one hour respectively. Following cooling to room temperature, the projections were inspected for shape and measured for thickness, and in each case, the projections for controlling liquid crystal alignment exhibited no change from prior to heating (Table 2).

<Evaluation of Pattern Chemical Resistance>

The substrates having projections for controlling liquid crystal alignment obtained in the examples 1 and 2 and the comparative example 2 were placed in 25° C. pure water for 30 minutes, 50° C. pure water for 30 minutes, 25° C. isopropyl alcohol for 30 minutes, or 25° C. N-methylpyrrolidone for 5 minutes respectively, were subsequently lifted out of the liquid and dried, and the projections were then inspected for shape and measured for thickness, and in each case, the projections for controlling liquid crystal alignment exhibited no change from prior to immersion in the chemical (Table 2).

In Table 2, the symbol O represents the result of an evaluation of the heat resistance or the chemical resistance, and indicates that no change was observed in the shape or thickness of the projections.

As described above, in the comparative example 1, where the proportion of the monofunctional reactive monomer within the total mass of the blended reactive monomers was less than 50%, the shape of the projections following curing treatment was rectangular, indicating that a smoothly curved surface was not obtained, whereas in the comparative example 2, which used a positive resist, the precision of the thickness of the projections for controlling liquid crystal alignment was unable to achieve the targeted precision of ±0.1 μm

If the examples 1 and 2 are compared, then it is evident that the example 2, wherein the resin composition layer was formed on the glass substrate using a film-like negative photosensitive element exhibited an even higher level of precision in the thickness of the projections for controlling liquid crystal alignment, and more favorable stability of the film thickness than the example 1, wherein the resin composition layer was formed on the glass substrate by spin coating of a liquid negative photosensitive resin composition

[Table 1]

TABLE 1
Blend quantities within negative photosensitive resin compositions

| | | | Comparative |
|---|---|---|---|
| Item | Material | Example 1 | example 1 |
| (a) Alkali-soluble | Copolymer of methacrylic | 70 | Same |
| resin | acid/2-hydroxyethyl | (solid | |
| | methacrylate/benzyl | fraction) | |
| | methacrylate—75/15/10 | | |
| (b) Reactive | Polyoxyethylenated | 8 | 22 |
| monomer | bisphenol A dimethacrylate | | |
| | β-hydroxyethyl-β′- | 22 | 8 |
| | acryloyloxy-o-phthalate | | |
| (c) Photoreaction | 2-(o-chlorophenyl)-4,5- | 3.52 | Same |
| initiator | diphenylimidazole dimer | | |
| | N,N,N′,N′-tetramethyl-4,4′- | 0.3 | Same |
| | diaminobenzophenone | | |
| | 2-mercaptobenzimidazole | 1.17 | Same |
| Additives | SZ6030 | 3 | Same |
| | (coupling agent, manu- | | |
| | factured by Toray | | |
| | Dow Corning Silicone Co., | | |
| | Ltd.) | | |
| | SH-30PA | 0.14 | Same |
| | (leveling agent, | | |
| | manufactured by Toray | | |
| | Dow Corning Silicone Co., | | |
| | Ltd.) | | |
| Solvent | Methyl ethyl ketone | 56 | same |

[Table 2]

TABLE 2
Results of patterning, and heat resistance and chemical resistance of
projections for controlling liquid crystal alignment

| | | | | Comparative | Comparative |
|---|---|---|---|---|---|
| Item | | Example 1 | Example 2 | example 1 | example 2 |
| After | Pattern shape | Rectangular | Rectangular | Rectangular | Rectangular |
| developing | | | | | |
| After heat | Pattern shape | Curved | Curved | Rectangular | Curved |
| treatment | Pattern height (μm) | 1.3 | 1.3 | — | 1.3 |
| | Pattern precision (μm) | ±0.1 | ±0.05 | — | ±0.2 |
| Heat resistance | 250° C., 1 hour | ◯ | ◯ | — | ◯ |
| Chemical | Water | ◯ | ◯ | — | ◯ |
| resistance | (25° C., 30 min.) | | | | |
| | Water | ◯ | ◯ | — | ◯ |
| | (50° C., 30 min.) | | | | |
| | Isopropyl alcohol | ◯ | ◯ | — | ◯ |
| | (25° C., 30 min.) | | | | |
| | N-methylpyrrolidone | ◯ | ◯ | — | ◯ |
| | (25° C., 5 min.) | | | | |

### INDUSTRIAL APPLICABILITY

A negative photosensitive resin composition of the present invention can be used favorably for forming projections for controlling liquid crystal alignment. The projections for controlling liquid crystal alignment according to the present invention exhibit excellent height precision, meaning that compared with the case in which a positive photosensitive resin composition is used, a substrate having more uniform projections for controlling liquid crystal alignment can be obtained, and a liquid crystal panel tit uses the substrate can be produced with excellent yield.

1. A negative photosensitive resin composition for forming projections having a curved surface, comprising an alkali-soluble resin (a), a reactive monomer (b), and a photoreaction initiator (c), wherein 50% or more of a total mass of the blended reactive monomer (b) is a monofunctional reactive monomer.

2. The negative photosensitive resin composition for forming projections according to claim 1, wherein a surface shape of the projections is a smoothly curved surface.

3. The negative photosensitive resin composition for forming projections according to claim 1, wherein a height of the projections is within a range from 0.5 to 5 μm.

4. The negative photosensitive resin composition for forming projections according to claim 1, wherein precision of the height of the projections is no greater than ±0.1 μm.

5. The negative photosensitive resin composition for forming projections according to claim 1, wherein a proportion of the monofunctional reactive monomer within the total mass of the blended reactive monomer (b) is within a range from 50 to 90% by mass.

6. The negative photosensitive resin composition for forming projections according to claim 5, wherein a proportion of the monofunctional reactive monomer within the total mass of the blended reactive monomer (b) is within a range from 60 to 85% by mass.

7. The negative photosensitive resin composition for forming projections according to claim 6, wherein a proportion of the monofunctional reactive monomer within the total mass of the blended reactive monomer (b) is within a range from 70 to 80% by mass.

8. A negative photosensitive resin composition for forming projections for controlling liquid crystal alignment, comprising an alkali-soluble resin (a), a reactive monomer (b), and a photoreaction initiator (c), wherein 50% or more of a total mass of the blended reactive monomer (b) is a monofunctional reactive monomer.

9. The negative photosensitive resin composition for forming projections for controlling liquid crystal alignment according to claim 8, wherein a surface shape of the projections is a smoothly curved surface.

10. The negative photosensitive resin composition for forming projections for controlling liquid crystal alignment according to claim 8, wherein a height of the projections is within a range from 0.5 to 5 μm.

11. The negative photosensitive resin composition for forming projections for controlling liquid crystal alignment according to claim 8, wherein precision of the height of the projections is no greater than ±0.1 μm.

12. The negative photosensitive resin composition for forming projections for controlling liquid crystal alignment according to claim 8, wherein a proportion of the monofunctional reactive monomer within the total mass of the blended reactive monomer (b) is within a range from 50 to 90% by mass.

13. The negative photosensitive resin composition for forming projections for controlling liquid crystal alignment according to claim 12, wherein a proportion of the monofunctional reactive monomer within the total mass of the blended reactive monomer (b) is within a range from 60 to 85% by mass.

14. The negative photosensitive resin composition for forming projections for controlling liquid crystal alignment according to claim 13, wherein a proportion of the monofunctional reactive monomer within the total mass of the blended reactive monomer (b) is within a range from 70 to 80% by mass.

15. A negative photosensitive element, comprising a negative photosensitive resin composition layer that uses either the negative photosensitive resin composition for forming projections according to claim 1, positioned on top of a support.

16. A method of producing projections having a curved surface, comprising at least:
(I) a step of layering either the negative photosensitive resin composition according to claim 1 onto a substrate, thereby forming a negative photosensitive resin composition layer on top of the substrate,
(II) a step of patterning the negative photosensitive resin composition layer by irradiation with an activation light beam,
(III) a step of generating a resin pattern by developing, and
(IV) a step of heating the resin pattern.

17. A method of producing projections for controlling liquid crystal alignment, comprising at least:
(I) a step of layering either the negative photosensitive resin composition according to claim 8 onto a substrate, thereby forming a negative photosensitive resin composition layer on top of the substrate,
(II) a step of patterning the negative photosensitive resin composition layer by irradiation with an activation light beam,
(III) a step of generating a resin pattern by developing, and
(IV) a step of heating the resin pattern.

18. A method of producing projections for controlling liquid crystal alignment, comprising at least:
(I) a step of layering either the negative photosensitive resin composition according to claim 8 onto a substrate, thereby forming a negative photosensitive resin composition layer on top of the substrate,
(II) a step of patterning the negative photosensitive resin composition layer by irradiation with an activation light beam,
(III) a step of generating a resin pattern by developing, and
(IV) a step of generating projections having smoothly curved surfaces by heating.

19. Projections having curved surfaces, produced using the method according to claim 16.

20. Projections for controlling liquid crystal alignment, produced using the method according to claim 17.

21. A substrate having the projections for controlling liquid crystal alignment according to claim 20.

22. A liquid crystal panel that is produced using the substrate having projections for controlling liquid crystal alignment according to claim 21.

23. A negative photosensitive element, comprising a negative photosensitive resin composition layer that uses the negative photosensitive resin composition for forming projections for controlling liquid crystal alignment according to claim 8 positioned on top of a support.
